(19) United States
(12) Patent Application Publication
(10) Pub. No.: US 2011/0142344 A1
(43) Pub. Date: Jun. 16, 2011

(54) BROWSING SYSTEM, SERVER, AND TEXT EXTRACTING METHOD

(75) Inventor: Toshimitsu FUKUSHIMA, Tokyo (JP)

(73) Assignee: FUJIFILM Corporation, Tokyo (JP)

(21) Appl. No.: 12/962,512

(22) Filed: Dec. 7, 2010

(30) Foreign Application Priority Data
Dec. 11, 2009 (JP) JP2009-281880

(51) Int. Cl. G06K 9/18

(52) U.S. Cl. 382/182

(57) ABSTRACT

In order to precisely extract a character in an image displayed at a terminal device in the case that an imaged web page is sent to the terminal device and the web page is browsed at the terminal device, a server acquires the web page from the Internet, generates the image from the acquired web page, and sends the image to a client terminal, the client terminal receives the image, displays the image on a display part, specifies a rectangular area, and sends information regarding the specified rectangular area to the server, and the server extracts the image in the rectangular area from the image of the web page, recognizes a text by an OCR process, extracts a text from a source of an HTML file which matches the recognized text most closely, and sends the extracted text to the client terminal.

### BACKGROUND OF THE INVENTION

1. Field of the Invention

The present invention relates to a browsing system, a server, and a text extracting method. In particular, the present invention relates to a browsing system, a server, and a text extracting method configured to allow a user to browse a web page by a portable terminal.

2. Description of the Related Art

Recently, many cellular phones are equipped with a full browser to enable a cellular phone user to browse a web page created for a personal computer user. However, in the case of browsing the web page created for a personal computer user by a cellular phone, there may occur the problem that the layout of the web page may collapse to make the browsing of the web page difficult, or the like because the display size of the cellular phone is small. Access to some of in-house intranet pages, or the like is limited to secure safety and cannot be browsed by the cellular phone.

As one of methods to solve the above-mentioned problem, a system in which a server generates an image of a web page or an intranet page and distributes the image to the cellular phone can be considered.

Japanese Patent Application Laid-Open No. 2004-220260 discloses a system which makes a web page rendered at a server and distributes the page converted into an image to a client.

Japanese Patent Application Laid-Open No. 2005-327258 discloses a system in which an area to be subject to an OCR (Optical Character Recognition) process is specified through a web browser at a client apparatus and a server performs the OCR process.

Japanese Patent Application Laid-Open No. 2006-350663 discloses a system in which image data is processed by a character recognition (OCR process) to extract a text, and the extracted text data is processed by a syntax semantic analysis to detect and correct an error in a sentence to thereby improve accuracy of the character (sentence) recognition.

However, the invention disclosed in Japanese Patent Application Laid-Open No. 2004-220260 does not allow a user to perform an operation like selecting and copying a text area since a web page distributed to a client is imaged.

The invention disclosed in Japanese Patent Application Laid-Open No. 2005-327258 enables a text data to be obtained from an image data by an OCR process, but Japanese Patent Application Laid-Open No. 2005-327258 does not disclose a method for improving accuracy of the text data.

The invention disclosed in Japanese Patent Application Laid-Open No. 2006-350663 does not allow a syntax semantic analysis to be performed in the case that the accuracy of the OCR process is low, and, as a result, the correct text data cannot be obtained. And even in the case that the syntax semantic analysis can be performed, there is a problem that a text data obtained by the syntax semantic analysis is unable to be a text data actually contained in the image data.

### SUMMARY OF THE INVENTION

Accordingly, an object of the present invention is to provide a browsing system, and a server, and a text extracting method which can precisely extract a character contained in a predetermined area in an image displayed at a terminal in the case that an imaged web page is sent to the terminal and the web page is browsed at the terminal.

The browsing system described in the first aspect includes a terminal equipped with a display device and a server connected to the terminal, wherein the terminal includes a terminal side receiving device which receives image data sent from the server, a display control device which causes the display device to display the image based on the received image data, a selecting device which selects a predetermined area in the image displayed on the display device, and a terminal side sending device which sends information regarding the selected predetermined area to the server, the server includes an acquiring device which acquires a source of the web page, an image generating device which generates the image data of the web page based on the acquired source of the web page, a server side sending device which sends the generated image data to the terminal, a server side receiving device which receives the information regarding the predetermined area sent from the terminal, a character recognizing device which recognizes a character from the image in the predetermined area by the OCR process based on the received information regarding the predetermined area and the generated image data, and a character string extracting device which extracts a character string which is assumed to be the character recognized by the OCR process from the acquired source of the web page, the server side sending device sends the extracted character string to the terminal, and the terminal side receiving device receives the sent character string.

According to the browsing system described in the first aspect, at the server, the source of the web page is acquired, the image data of the web page is generated based on the acquired source of the web page, and the generated image data is sent to the terminal. At the terminal, the sent image data is received, the image is displayed on the display device based on the received image data, the predetermined area within the image displayed on the display device is selected, and the information regarding the selected predetermined area is sent to the server. At the server, the information regarding the predetermined area sent from the terminal is received, the character is recognized from the image in the predetermined area by the OCR process based on the received information regarding the predetermined area and the generated image data, the character string which is assumed to be the character recognized by the OCR process is extracted from the acquired source, and the extracted character string is sent to the terminal. At the terminal, the character string sent from the server is received. Accordingly, even if an incorrect text is recognized due to an error of the OCR process, the error can be corrected and an accurate text data contained in the selected area can be obtained. Even in the case that the accuracy of the OCR process is reduced, for example, the OCR process is performed on an underlined character, a part of a table, or the like, the accurate text data can be obtained.

As described in the second aspect, the server of the browsing system as specified in the first aspect further includes a determining device which determines whether or not the size of the predetermined area is equal to or more than a threshold value and the server side sending device sends the character string recognized by the OCR process if the size of the predetermined area is determined not to be equal to or more than the threshold value.

According to the browsing system described in the second aspect, the server determines whether or not the size of the predetermined area is equal to or more than the threshold value, and the character string recognized by the OCR process is sent to the terminal if the size of the predetermined area is determined not to be equal to or more than the threshold value. As a result, the text data contained in the selected area can be obtained efficiently with high accuracy.

As described in the third aspect, in the browsing system as specified in the first aspect or the second aspect, the terminal side sending device sends information of the coordinates of the predetermined area as the information regarding the predetermined area to the server, and the character recognizing device extracts the image in the predetermined area based on the generated image data and the information of the coordinates of the predetermined area and recognizes the character from the extracted image in the predetermined area.

According to the browsing system described in the third aspect, when the information of the coordinates of the predetermined area is sent from the terminal to the server as the information regarding the predetermined area, the image in the predetermined area is extracted based on the generated image data and the information of the coordinates of the predetermined area and the character is recognized from the extracted image in the predetermined area at the server. As a result, the server of which performance is relatively high performs a CPU-consuming process: extracting the image in the specified area based on the coordinates, and the operation performed on the terminal of which performance is relatively low can be just sending the coordinates of a small rectangular area, of which process cost is low.

As described in the fourth aspect, the character string extracting device of the browsing system as specified in the first aspect, the second aspect, or the third aspect compares the character recognized by the OCR process with a text contained in the acquired source and extracts the character string which matches the character recognized by the OCR process most closely.

According to the browsing system described in the fourth aspect, the character string extracting device compares the character recognized by the OCR process with the text contained in the acquired source and extracts the character string which matches the character recognized by the OCR process most closely. Consequently, the text data contained in the selected area from the source can be extracted.

As described in the fifth aspect, the terminal of the browsing system as specified in one of the first aspect through the fourth aspect further includes a storage device which stores the received character string.

According to the browsing system described in the fifth aspect, the character string sent from the server is stored in the storage device of the terminal. Consequently, the text sent from the server can be utilized for pasting the text to an arbitrary text field, or the like. In other words, the same effect as copying the text contained in the image in the area selected at the client terminal can be achieved.

The server described in the sixth aspect constitutes the browsing system specified in one of the first aspect through the fifth aspect.

The text extracting method described in the seventh aspect includes a step for receiving from a portable terminal a request to browse a web page, a step for acquiring the source of the web page based on the received request to browse the web page, a step for generating image data of the web page based on the acquired source of the web page, a step for receiving information regarding a predetermined area from the terminal, a step for recognizing a character from the image in the predetermined area by an OCR process based on the received information regarding the predetermined area and the generated image data, a step for extracting a character string which is assumed to be the character recognized by the OCR process from the acquired source, and a step for sending the extracted character string to the terminal.

The text extracting program described in the eighth aspect enables the text extracting method described in the seventh aspect to be performed by a computing apparatus.

According to the present invention, in the case that the imaged web page is sent to the terminal and the web page is browsed at the terminal, the character contained in the predetermined area in the image displayed at the terminal can be precisely extracted.

### BRIEF DESCRIPTION OF THE DRAWINGS

FIG. 1 is a schematic diagram showing a browsing system 1 to which the present invention is applied;

FIG. 2 is a schematic diagram showing a server constituting the browsing system 1;

FIG. 3 is a schematic diagram showing a client terminal constituting the browsing system 1;

FIG. 4 is a flow chart showing a flow of processes in which the client terminal of the browsing system 1 copies text data;

FIG. 5 shows one example of an image for browsing displayed at the client terminal;

FIG. 6 is a chart for explaining an OCR process;

FIG. 7 is a chart for explaining a text extracting process;

FIG. 8 is a chart for explaining a method for extracting a text with the highest degree of matching;

FIG. 9 is a chart for explaining a text sending process;

FIG. 10 is a flow chart showing a flow of processes in which a client terminal of a browsing system 2 to which the present invention is applied copies text data; and

FIG. 11 is a chart for explaining a text extracting process of the browsing system 2.

### DETAILED DESCRIPTION OF THE PREFERRED EMBODIMENTS

### First Embodiment

A browsing system 1 mainly includes a server 10 and a client terminal 20. There may be single or multiple client terminals 20 connected to the server 10.

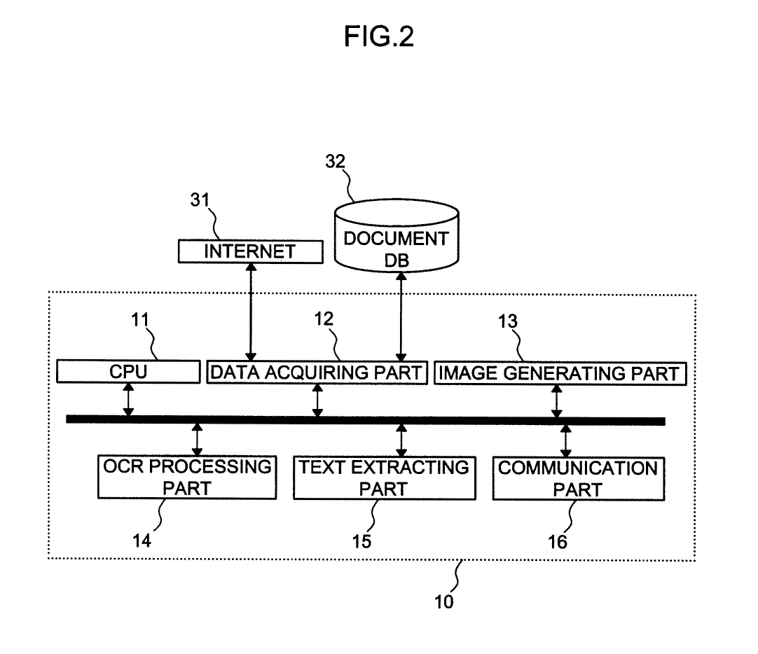

As shown in FIG. 2, the server 10 mainly includes a CPU 11, a data acquiring part 12, an image generating part 13, an OCR processing part 14, a text extracting part 15, and a communication part 16.

The CPU 11 functions as a computing device which performs various computing processes as well as a controlling device which supervises and controls the entire operation of the server 10. The CPU 11 includes a firmware which is a control program, a browser which is a program for displaying a web page, and a memory area which stores various data necessary for controlling, and the like. The CPU 11 further includes a memory area used as a temporary memory area for image data to be displayed, or the like as well as a working area for the CPU 11.

The data acquiring part 12 is connected to the Internet 31 and acquires content of the web page, or the like requested by the client terminal 20 through the Internet 31. And the data acquiring part 12 is connected to a document data base (DB) 32 and acquires various data such as a document file requested by the client terminal 20 from the document DB 32.

The image generating part 13 generates an image (called image for browsing hereinafter) from the content or the document data acquired by the data acquiring part 12. The image generating part 13 stores the generated image for browsing into the memory area of the CPU 11.

The OCR processing part 14 recognizes a character contained in the inputted image and converts the recognized character to a text. As an OCR process is a general technique, detailed description thereof will be omitted.

The text extracting part 15 extracts a text from the source of the web page acquired by the CPU 11 which matches the text acquired by the OCR processing part 14 most closely. Also, the text extracting part 15 extracts a text from the document data acquired by the CPU 11 which matches the text acquired by the OCR processing part 14 most closely. Details of the process of the text extracting part 15 will be described later.

The communication part 16 sends the image for browsing, or the like to the client terminal 20. And the communication part 16 receives a request to browse the web page, or the like sent from the client terminal 20.

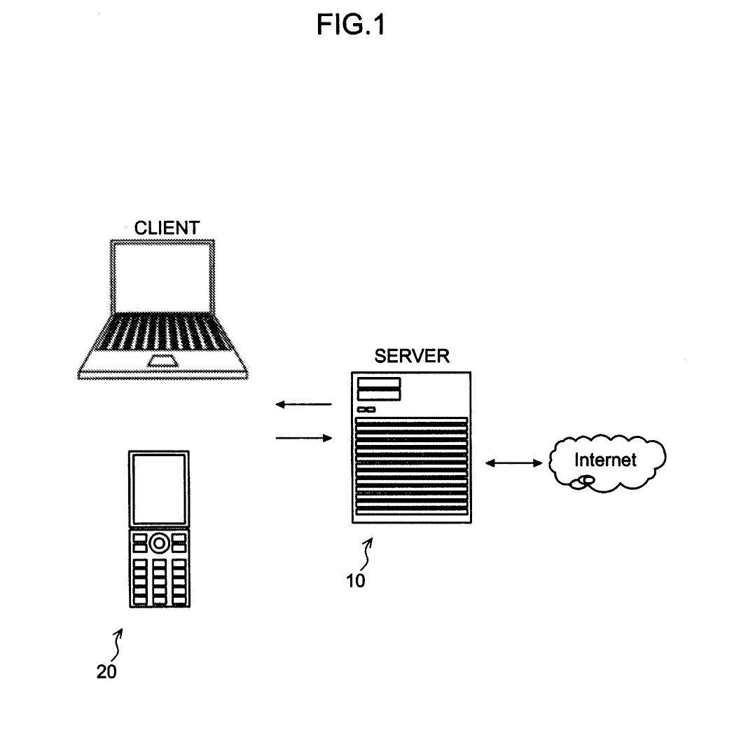

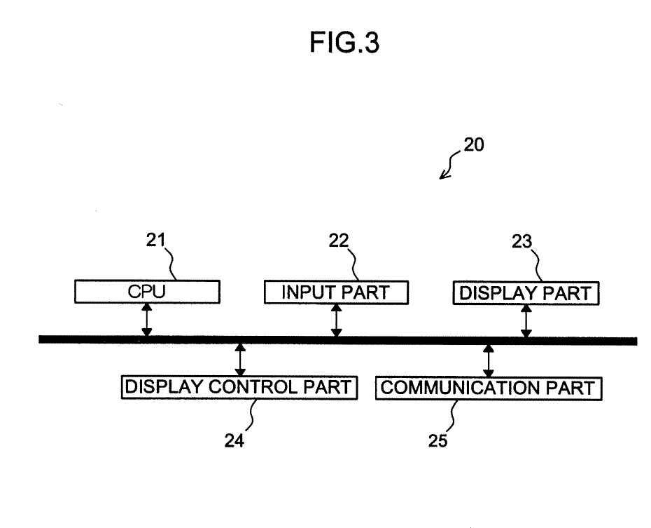

The client terminal 20 is, for example, a small notebook PC, a cellular phone, or the like, and is connected to the server 10 via network as depicted in FIG. 1. As depicted in FIG. 3, the client terminal 20 mainly includes a CPU 21, an input part 22, a display part 23, a display control part 24, and a communication part 25. Note that the client terminal 20 is not limited to a small notebook PC or a cellular phone and may be any information terminal which can execute a web browser.

The CPU 21 supervises and controls the entire operation of the client terminal 20, and also functions as a computing device which performs various computing processes. The CPU 21 includes a memory area in which client terminal information of the client terminal 20, programs necessary for various control, and the like are stored. The CPU 21 further includes a buffer for temporarily storing various data sent from the server 10.

The input part 22 is designed for a user to input various instructions and includes a ten-key keyboard, a cross-key, and the like.

The display part 23 is, for example, a liquid crystal display capable of displaying color. Note that the display part 23 is not limited to a color display, and may be a monochrome display. And the display part 23 is not limited to be configured with a liquid crystal display, and may be configured with an organic electroluminescence display, or the like.

The display control part 24 causes the image for browsing sent from the server 10 to be displayed on the display part 23.

The communication part 25 receives the image for browsing, text data, and the like sent from the server 10. And the communication part 25 sends the request to browse the web page, information regarding an area, and the like to the server 10.

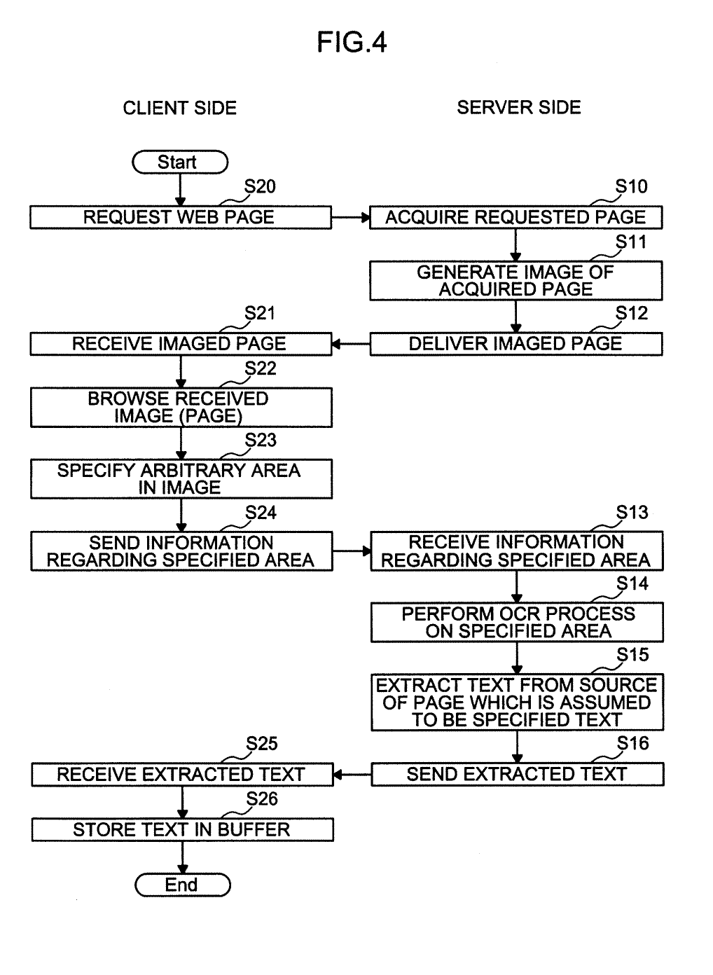

An operation of the browsing system 1 configured as described above will be described. When the image of the web page (or the document data) is displayed at the client terminal 20 and a predetermined area is selected on the client terminal 20, the browsing system 1 enables a text contained in the area to be copied. FIG. 4 is a flow chart showing a flow of processes in which the client terminal 20 copies the text in the web page displayed on the display part 23.

The CPU 21 of the client terminal 20 activates the web browser stored in the memory area. When information (URL, or the like) regarding the web page to be browsed is inputted through the input part 22, the CPU 21 sends the request to the server 10 upon receiving the information (step S20).

The CPU 11 of the server 10 submits an instruction to the data acquiring part 12 upon receiving the request and the data acquiring part 12 acquires the requested web page from the Internet (step S10). In this case, the server 10 acts as a proxy and acquires a content (for example, an HTML file corresponding to the web page) from external servers. The CPU 11 stores the acquired content into the buffer. Note that the server 10 may act as a web server, in which case the server 10 acquires the content stored in a memory which is not shown herein.

The data acquiring part 12 outputs the acquired content to the image generating part 13, and the image generating part 13 generates the image for browsing from the content (step S11). In the case that the HTML file corresponding to the web page is acquired, the image generating part 13 analyzes the HTML file, generates an image (rendering) of resultant characters and images appropriately arranged based on the result of analyzing the HTML file, and saves the generated image as an image file such as gif, or jpeg.

The image generating part 13 outputs the generated image for browsing to the CPU 11 and the CPU 11 sends the image for browsing to the client terminal 20 (step S12).

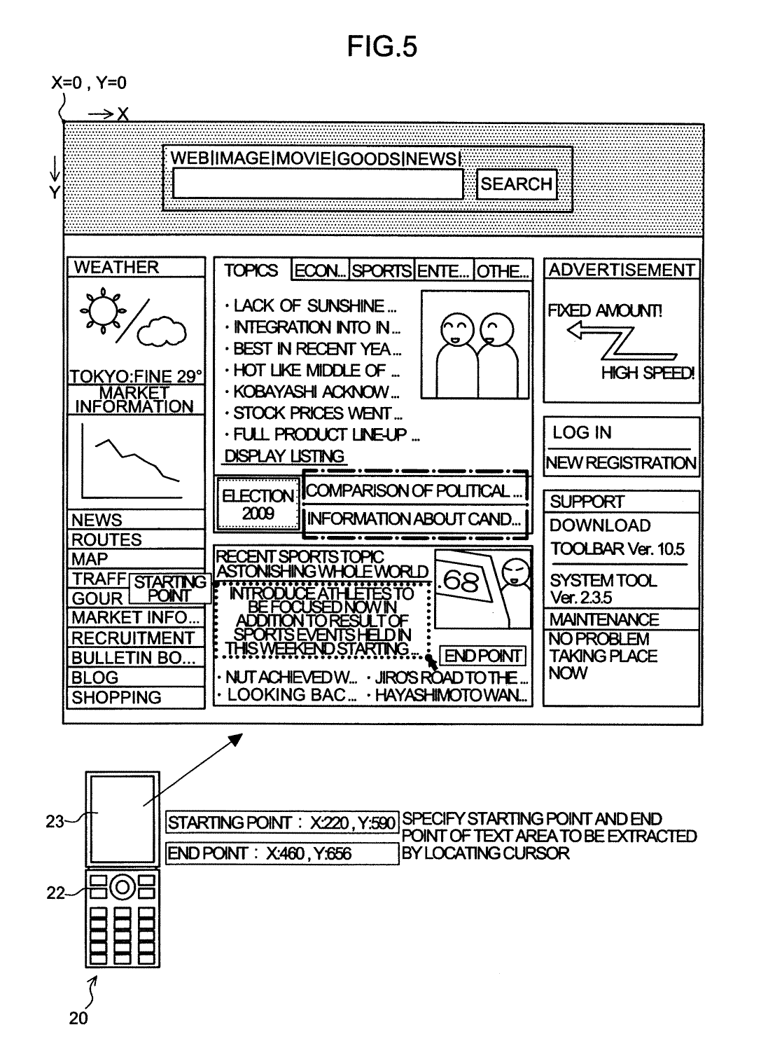

The CPU 21 of the client terminal 20 receives the image for browsing sent from the server 10 (step S21) and outputs the image for browsing to the display control part 24. The display control part 24 causes the display part 23 to display the received image (step S22). Accordingly, as shown in FIG. 5, the image of the requested web page is displayed at the client terminal 20, and a user can browse the web page.

While the image for browsing is displayed on the display part 23, the area from which the text is to be extracted (copied) is specified through the input part 22 (step S23). The area is specified, for example, by a user locating a cursor with the cross-key, or the like of the input part 22 to selectively input the location of a starting point and an end point of the area. When the CPU 21 detects the input result produced by the input part 22, the CPU 21 recognizes as shown in FIG. 5 that a rectangular area formed by the starting point and the end point is specified. Note that the way of specifying the area is not limited to the present embodiment and specifying the area can be performed in various ways, such as by directly inputting the coordinate values of the starting point and the end point.

The CPU 21 sends the information regarding the recognized rectangular area to the server 10 (step S24). The information regarding the rectangular area can be considered to be the coordinates of the starting point and the end point of the area. In the case shown in FIG. 5, the top left point of the image for browsing is assumed to be the origin (both X coordinate and Y coordinate are 0) of the coordinate axes and the coordinate is specified in the manner that the right direction indicates a positive X direction and the down direction indicates a positive Y direction. Note that the way of specifying the coordinate is not limited to the one described above. The CPU 21 may capture the rectangular area from the image for browsing and send the captured image as the information regarding the rectangular area.

The CPU 11 of the server 10 receives the information regarding the rectangular area sent from the client terminal 20 (step S13). The CPU 11 outputs the information regarding the rectangular area to the OCR processing part 14.

The OCR processing part 14 recognizes the character contained in the rectangular area based on the information regarding the rectangular area (step S14). In the case that the coordinates of the starting point and the end point of the rectangular area are inputted as the information regarding the rectangular area, the OCR processing part 14 acquires the image for browsing from the image generating part 13 and captures the image of the rectangular area based on the image for browsing and the coordinates. In the present embodiment, the OCR processing part 14 captures the image of the area surrounded by a dotted line in FIG. 5 as the image of the rectangular area.

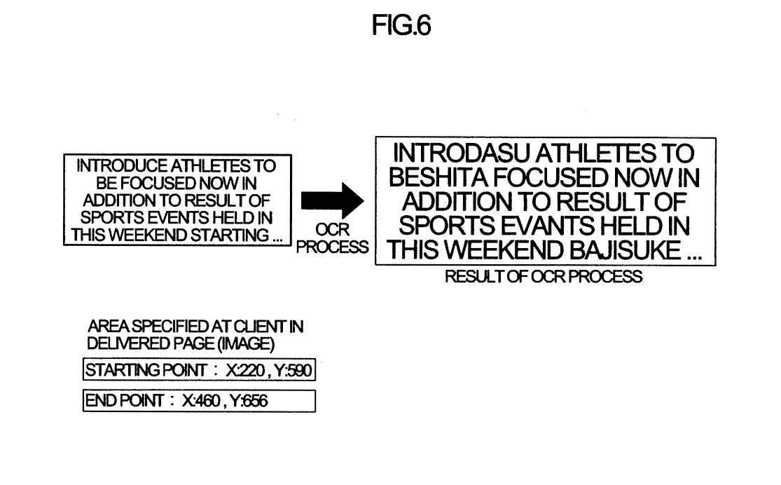

The OCR processing part 14 recognizes the character contained in the rectangular area by performing the OCR process on the captured image. As shown in FIG. 6, the OCR processing part 14 performs the OCR process on characters as follows: “Introduce athletes to be focused now in addition to the result of sports events held in this weekend starting with the international athletic event held in Berlin” contained in the rectangular area and obtains the recognition result as follows: “Introdasu athletes to beshita focused now in addition to the result of sports events held in this weekend bajisuke with the international athletic event held in Berlin”.

In the case that the image captured from the image for browsing is inputted as the information regarding the rectangular area, since the operation of extracting the image based on the coordinate information is not required, the OCR processing part 14 directly performs the OCR process on the inputted image to recognize the character. As for the embodiment of the browsing system, since the server shows higher performance than the client terminal in general, it is preferable that the client terminal just sends the coordinates of the small rectangular area, of which process cost is low, and the server extracts the image in the predetermined area based on the coordinates.

The OCR processing part 14 outputs the recognized result obtained by the OCR process as the text data to the text extracting part 15. The text extracting part 15 acquires the HTML file stored in the buffer and extracts the text from texts contained in the source of the HTML file which is assumed to be the inputted text data (step S15). The process at step 15 is performed, for example, by extracting the text matching most closely from the source with utilizing the inputted text data as a key. In the present embodiment, the HTML file is used as the source of the page, but the source of the page is not limited to the HTML file and may be any information necessary for rendering the original web page of the image for browsing sent to the client terminal 20.

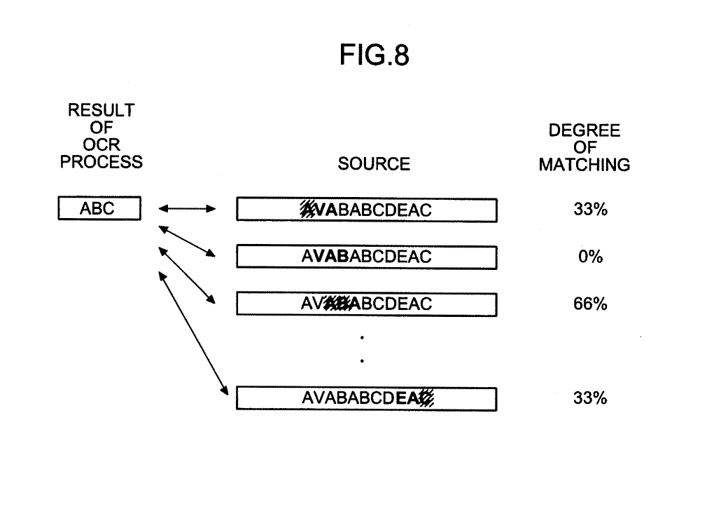

A method of extracting the text with the highest degree of matching will be described with reference to FIG. 8. In the case that a text “ABC” is recognized by the OCR processing part 14, the text extracting part 15 compares the text “ABC” with the source sequentially and calculates a degree of matching. For example, the degree of matching between the text “ABC” and a text “AVA” in the source is 33 percent, the degree of matching between the text “ABC” and a text “VAB” in the source is 0 percent, the degree of matching between the text “ABC” and a text “ABA” in the source is 66 percent, and the degree of matching between the text “ABC” and a text “EAC” in the source is 33 percent. Since the highest degree of matching takes place when comparing the text “ABC” with the text “ABA” in the source, the text extracting part 15 extracts the text “ABA” in the source.

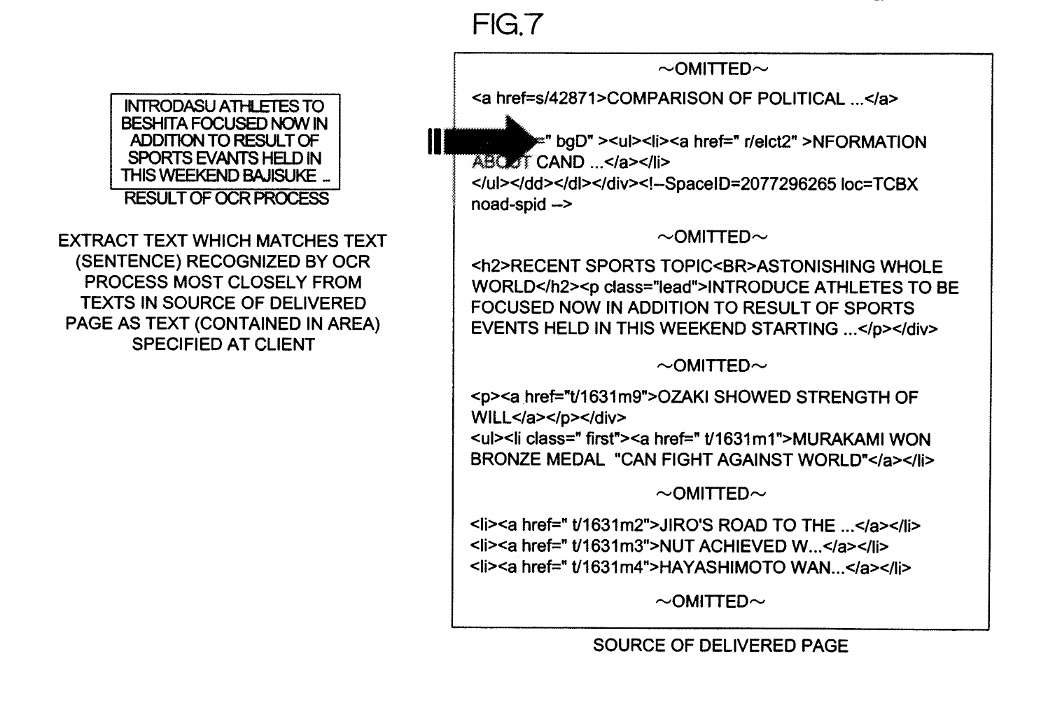

In the case shown in FIG. 7, the text extracting part 15 extracts the most closely matching text from the source with using the text “Introdasu athletes to beshita focused now in addition to the result of sports events held in this weekend bajisuke with the international athletic event held in Berlin” recognized at step S14 as a key. As a result, the text extracting part 15 extracts the text “Introduce athletes to be focused now in addition to the result of sports events held in this weekend starting with the international athletic event held in Berlin”.

The text extracting part 15 determines that the extracted text is the text contained in the rectangular area specified at the client terminal 20. The text contained in the rectangular area specified at the client terminal 20 is always the text contained in the source. Therefore, even if an incorrect text is recognized by an error of the OCR process, extracting the text from the texts contained in the source by guessing from the text obtained by the OCR process enables the error to be corrected and the correct text to be extracted.

Note that the HTML file acquired at step S10 and stored in the buffer is used at step S15 in the present embodiment, the HTML file may be acquired anew prior to the process of step S15. And, at step S15, all the texts contained in the source may be a target to be extracted, or in the case that the source is the HTML file which includes meta-information (tag), or the like, only the target text for rendering excluding a tag may be a target to be extracted.

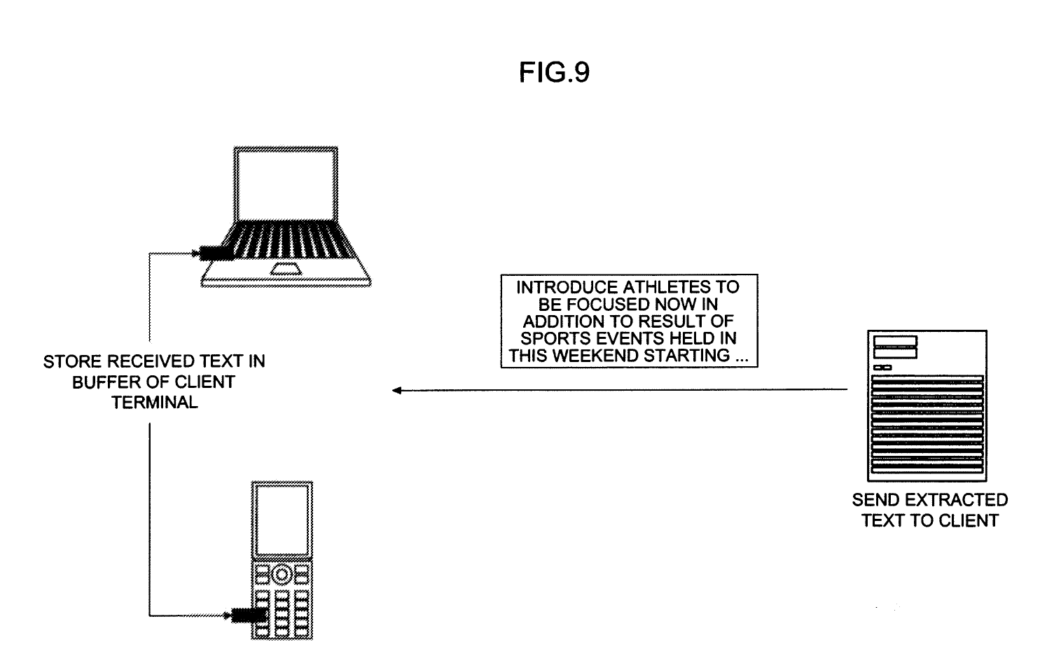

The text extracting part 15 outputs the extracted text to the CPU 11, and, as shown in FIG. 9, the CPU 11 sends the text to the client terminal 20 (step S16). The CPU 21 of the client terminal 20 receives the text sent from the server 10 (step S25) and stores the received text in the buffer in the CPU 21 (step S26). It is conceivable that the text stored in the buffer is used, for example, for pasting the text to an arbitrary text field, or the like.

According to the present embodiment, in the case that the image of the web page or the document data is generated to enable the generated image to be displayed at the client terminal, selecting a part of the image displayed at the client terminal enables the accurate text data contained in the selected area to be obtained. And storing the obtained text data can provide the same effect as copying the text contained in the image in the area selected at the client terminal.

A conventional thin-client type browser cannot copy the text contained in the web page since the web page to be browsed at the client terminal is imaged. However, combining the OCR process with text extraction from the source enables even the thin-client type browser to copy and paste a desired text.

And according to the present embodiment, even in the case that the accuracy of the OCR process is reduced, for example, the OCR process is performed on an underlined character, or a part of a table, the accurate text data can be copied. For example, in the case that an area surrounded by an alternate long and short dash line in FIG. 5 is selected as the rectangular area at step S23, the accurate recognition result of a text in the upper row cannot be obtained by the OCR process at step S14 due to a line extending midway between the rows. However, as shown in FIG. 7, comparing the recognition result with the source enables the texts as follows: “comparison of political commitments between parties”, “security”, “information about candidates”, “manifest”, and “news about election” to be extracted.

Note that, as shown in FIG. 4, the operation of the present embodiment has been described with the case of browsing the web page as an example, but the text in the selected rectangular area can be extracted in the case of browsing the document data as well as browsing the web page with the same method as the one described in the present embodiment.

### Second Embodiment

According to the first embodiment, even in the case that an incorrect text is obtained by an error of the OCR process, the operation of extracting a text from the texts contained in the source is performed to correct the error and extract a correct text, but it is not always necessary to perform the operation of extracting the text from the source. For example, in the case that the text is short, such as a single word, the recognition result is often correct since the accuracy of the OCR process is high.

The second embodiment is an embodiment in which whether or not the operation of extracting the text is performed is determined based on the size of the rectangular area selected at the client terminal, in other words, the length of the text. A browsing system 2 according to the second embodiment will be described hereinafter. Note that since the configuration of the browsing system 2 is the same as that of the browsing system 1, the description thereof will be omitted. The same parts of the browsing system 2 as those of the browsing system 1 are designated by the same reference numerals and detailed description thereof will be omitted as well.

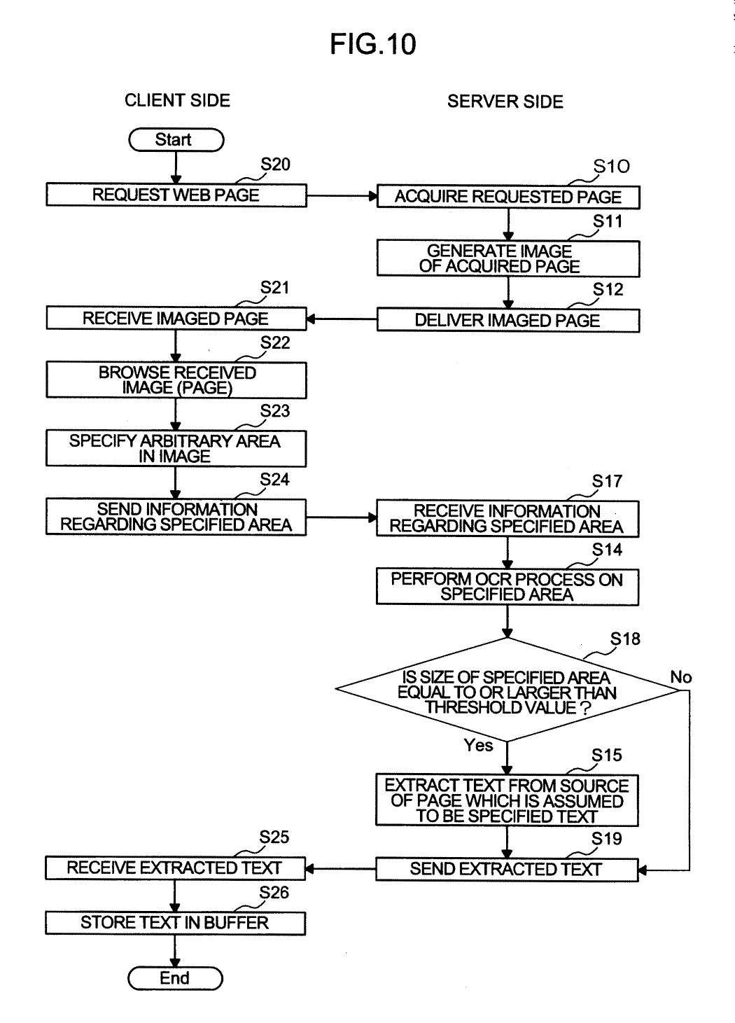

FIG. 10 is a flow chart showing a flow of processes in which the text in the area selected on a client terminal 20 is copied in the browsing system 2.

A CPU 21 of the client terminal 20 activates a web browser stored in a memory area. When information (URL, or the like) regarding the web page to be browsed is inputted through an input part 22, the CPU 21 sends a request to a server 10 upon receiving the information (step S20).

A CPU 11 of the server 10 submits an instruction to a data acquiring part 12 upon receiving the request and the data acquiring part 12 acquires the requested web page from the Internet (step S10). The data acquiring part 12 outputs the acquired content to an image generating part 13 and the image generating part 13 generates the image for browsing from the content (step S11). The image generating part 13 outputs the generated image for browsing to the CPU 11 and the CPU 11 sends the image for browsing to the client terminal 20 (step S12).

The CPU 21 of the client terminal 20 receives the image for browsing sent from the server 10 (step S21) and outputs the received image for browsing to a display control part 24. The display control part 24 causes a display part 23 to display the received image (step S22). Accordingly, the image of the requested web page is displayed at the client terminal 20 to enable a user to browse the web page.

While the image for browsing is displayed on the display part 23, a rectangular area from which the text is to be extracted (copied) is specified (step S23). The information regarding the specified rectangular area is detected by the CPU 21 and the CPU 21 sends the detected information regarding the rectangular area to the server 10 (step S24).

The CPU 11 of the server 10 receives the information regarding the rectangular area sent from the client terminal 20. The CPU 11 calculates the size (square measure) of the rectangular area based on the received information regarding the rectangular area (step S17).

The CPU 11 outputs the information regarding the rectangular area to an OCR processing part 14. The OCR processing part 14 recognizes a character contained in the rectangular area based on the information regarding the rectangular area (step S14).

The CPU 11 determines whether or not the size of the rectangular area received at step S13 is equal to or larger than a threshold value (step S18). Note that the threshold value is an arbitrary value which is set in advance and stored in a memory area of the CPU 11. The threshold value may be changed by the client terminal 20, or the like as the need arises. The threshold value is preferably set to the size of an area containing a text with a maximum character length (word-level length) from which the OCR process can obtain a correct recognition result.

In the case that the size of the rectangular area is equal to or larger than the threshold value (“YES” at step S18), the text contained in the area specified at the client terminal 20 is assumed to be a long text such as a sentence. In the case of a long text, the accuracy of the OCR process is reduced and the character is not recognized correctly in many cases. Accordingly, the OCR processing part 14 outputs the recognition result obtained by the OCR process as the text data to a text extracting part 15, and the text extracting part 15 extracts a text from the texts contained in the source of the HTML file stored in the buffer which text is assumed to be the inputted text data (step S15). The text extracting part 15 outputs the extracted text to the CPU 11 and the CPU 11 sends the text to the client terminal 20 (step S19). As a result, in the case that an incorrect text is highly likely recognized by an error of the OCR process, the error can be corrected and the correct text can be extracted.

In the case that the size of the rectangular area is less than the threshold value (“NO” at step S18), the text contained in the area specified at the client terminal 20 is assumed to be at a word-level. If the target to be recognized is a word, the accuracy of the OCR process is expected to be relatively high. And extracting a short text from the source may tend to lead to extracting an incorrect text and degrading the accuracy. Accordingly, in this case, the OCR processing part 14 outputs the obtained recognition result to the CPU 11, and the CPU 11 sends the text to the client terminal 20 (step S19).

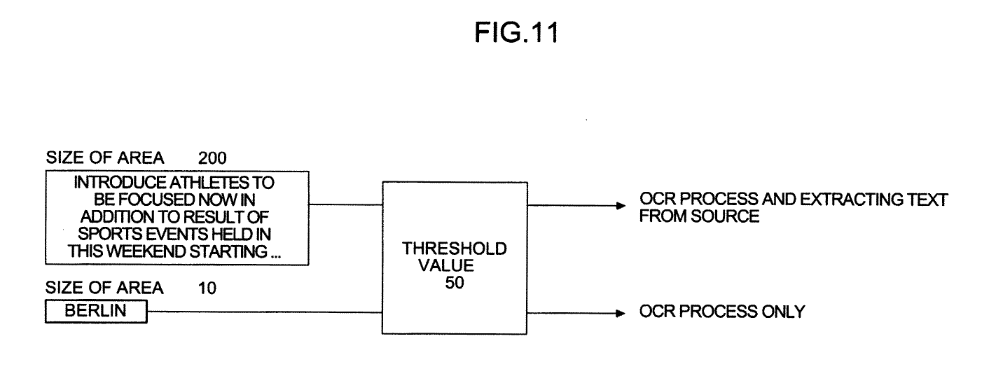

Detailed description of the processes from step S18 to step S19 will be provided with reference to FIG. 11. In the case that the threshold value is “50” and the size of the area calculated at step S17 is “200”, since the calculated size of the area, which is “200”, is larger than the threshold value, which is “50”, the text which is assumed to be correct is extracted from the texts contained in the source of the HTML file and the extracted text is determined to be the text contained in the rectangular area specified at the client terminal 20. On the contrary, in the case that the threshold value is “50” and the size of the area calculated at step S17 is “10”, since the calculated size of the area, which is “10”, is smaller than the threshold value, which is “50”, extracting the text is not performed and the recognition result obtained by the OCR process is determined to be the text contained in the rectangular area specified at the client terminal 20.

The CPU 21 of the client terminal 20 receives the text sent from the server 10 (step S25) and stores the received text in the buffer of the CPU 21 (step S26). It is conceivable that the text stored in the buffer is used, for example, for pasting the text to an arbitrary text field.

According to the present embodiment, changing the method of extracting the text to be sent depending on the size of the rectangular area enables an efficient and highly accurate process.

Note that, though the system including the server and the client terminal is described in the first and the second embodiment as an example, the present invention is not limited to the system and can be provided as a server distributing an image to an external device and as a program which is applied to the server and the client terminal.

What is claimed is:

1. A browsing system, comprising:
a terminal equipped with a display device; and
a server connected to the terminal, the terminal comprising:
a terminal side receiving device which receives image data sent from the server;
a display control device which causes the display device to display an image based on the received image data;
a selecting device which selects a predetermined area in the image displayed on the display device; and
a terminal side sending device which sends information regarding the selected predetermined area to the server, and the server comprising:
an acquiring device which acquires a source of a web page;
an image generating device which generates the image data of the web page based on the acquired source of the web page;
a server side sending device which sends the generated image data to the terminal;
a server side receiving device which receives the information regarding the predetermined area sent from the terminal;
a character recognizing device which recognizes a character from the image in the predetermined area by an OCR process based on the received information regarding the predetermined area and the generated image data; and
a character string extracting device which extracts a character string which is assumed to be the character recognized by the OCR process from the acquired source of the web page, wherein the server side sending device sends the extracted character string to the terminal, and the terminal side receiving device receives the sent character string.

2. The browsing system according to claim 1, wherein the server further comprises a determining device which determines whether or not the size of the predetermined area is equal to or more than a threshold value, and the server side sending device sends the character string recognized by the OCR process if the size of the predetermined area is determined not to be equal to or more than the threshold value.

3. The browsing system according to claim 1, wherein the terminal side sending device sends information of the coordinates of the predetermined area as the information regarding the predetermined area to the server, and the character recognizing device extracts the image in the predetermined area based on the generated image data and the information of the coordinates of the predetermined area and recognizes a character from the extracted image in the predetermined area.

4. The browsing system according to claim 2, wherein the terminal side sending device sends information of the coordinates of the predetermined area as the information regarding the predetermined area to the server, and the character recognizing device extracts the image in the predetermined area based on the generated image data and the information of the coordinates of the predetermined area and recognizes a character from the extracted image in the predetermined area.

5. The browsing system according to claim 1, wherein the character string extracting device compares the character recognized by the OCR process with texts contained in the acquired source and extracts the character string which matches the character recognized by the OCR process most closely.

6. The browsing system according to claim 2, wherein the character string extracting device compares the character recognized by the OCR process with texts contained in the acquired source and extracts the character string which matches the character recognized by the OCR process most closely.

7. The browsing system according to claim 3, wherein the character string extracting device compares the character recognized by the OCR process with texts contained in the acquired source and extracts the character string which matches the character recognized by the OCR process most closely.

8. The browsing system according to claim 4, wherein the character string extracting device compares the character recognized by the OCR process with texts contained in the acquired source and extracts the character string which matches the character recognized by the OCR process most closely.

9. The browsing system according to claim 1, wherein the terminal further comprises a storage device which stores the received character string.

10. The browsing system according to claim 2, wherein the terminal further comprises a storage device which stores the received character string.

11. The browsing system according to claim 3, wherein the terminal further comprises a storage device which stores the received character string.

12. The browsing system according to claim 4, wherein the terminal further comprises a storage device which stores the received character string.

13. The browsing system according to claim 5, wherein the terminal further comprises a storage device which stores the received character string.

14. The browsing system according to claim 6, wherein the terminal further comprises a storage device which stores the received character string.

15. The browsing system according to claim 7, wherein the terminal further comprises a storage device which stores the received character string.

16. The browsing system according to claim 8, wherein the terminal further comprises a storage device which stores the received character string.

17. The server of claim 1.

18. A text extracting method, comprising the steps of:
a step for receiving from a portable terminal a request to browse a web page;
a step for acquiring a source of a web page based on the received browsing request;
a step for generating image data of the web page based on the acquired source of the web page;
a step for receiving information regarding a predetermined area from the terminal;
a step for recognizing a character from the image in the predetermined area by an OCR process based on the received information regarding the predetermined area and the generated image data;
a step for extracting a character string from the acquired source which is assumed to be the character recognized by the OCR process; and
a step for sending the extracted character string to the terminal.

19. A programmable storage medium tangibly embodying a program of machine-readable instructions executable by a digital processing apparatus to perform the text extracting method according to claim 18.
